(19) United States
(12) Patent Application Publication
(10) Pub. No.: US 2009/0291824 A1
(43) Pub. Date: Nov. 26, 2009

(54) HONEYCOMB STRUCTURE

(75) Inventors: Kazushige OHNO, Ibi-Gun (JP); Masafumi Kunieda, Ibi-Gun (JP); Takahiko Ido, Ibi-Gun (JP)

Correspondence Address: DITTHAVONG MORI & STEINER, P.C., 918 Prince St., Alexandria, VA, 22314, US

(73) Assignee: IBIDEN CO., LTD., Ogaki-Shi (JP)

(21) Appl. No.: 12/355,999

(22) Filed: Jan. 19, 2009

(30) Foreign Application Priority Data
May 20, 2008 (JP) PCT/JP2008/059284

(51) Int. Cl. B01J 29/06; B01J 29/60; B01J 29/08; B01J 29/072; B01J 29/40; B01J 29/18

(52) U.S. Cl. 502/64; 502/60; 502/79; 502/74; 502/77; 502/78; 502/73

(57) ABSTRACT

A honeycomb structure includes a honeycomb structure includes a honeycomb unit. The honeycomb unit has thermal conductivity equal to or greater than about 0.15 W/m/K but less than or equal to about 0.60 W/m/K and has Young's modulus equal to or greater than about 1.5 MPa but less than or equal to about 7.0 Mpa. The honeycomb unit includes zeolite, an inorganic binder, and partition walls. The partition walls extend along a longitudinal direction of the honeycomb unit to define plural through holes.

### CROSS-REFERENCE TO RELATED APPLICATIONS

The present application claims priority under 35 U.S.C. §119 to PCT/JP2008/059284 filed on May 20, 2008. The contents of this application are incorporated herein by reference in their entirety.

### BACKGROUND OF THE INVENTION

1. Field of the Invention

The present invention relates to a honeycomb structure.

2. Discussion of the Background

Conventionally, an SCR (Selective Catalytic Reduction) system for reducing NOx to nitrogen and water using ammonia has been known as a system for converting exhaust gas of automobiles (see below).

4NO+4NH₃+O₂→4N₂+6H₂O

6NO₂+8NH₃→7N₂+12H₂O

NO+NO₂+2NH₃→2N₂+3H₂O

Zeolite has been known as a material for absorbing ammonia in the SCR system. Note that, generally, in the case where the SCR system is used as an exhaust gas treating device, a DOC (Diesel Oxidation Catalyst) is disposed upstream the SCR system in a direction of exhaust gas flow in order to oxidize HC (hydrocarbons).

PCT International Publication No. WO/06/137149 discloses a honeycomb structure, wherein honeycomb units include inorganic particles, and inorganic fibers and/or whiskers. The inorganic particles include at least one of alumina, silica, zirconia, titania, ceria, mullite, and zeolite.

The contents of PCT International Publication No. WO/06/137149 are incorporated by reference in their entirety.

### SUMMARY OF THE INVENTION

According to an aspect of the present invention, a honeycomb structure includes a honeycomb unit. The honeycomb unit has thermal conductivity equal to or greater than about 0.15 W/m/K but less than or equal to about 0.60 W/m/K and has Young's modulus equal to or greater than about 1.5 MPa but less than or equal to about 7.0 Mpa. The honeycomb unit includes zeolite, an inorganic binder, and partition walls. The partition walls extend along a longitudinal direction of the honeycomb unit to define plural through holes.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a perspective view illustrating an example of a honeycomb structure according to an embodiment of the present invention;

FIG. 2A is a perspective view illustrating another honeycomb structure according to an embodiment of the present invention; and

FIG. 2B is a perspective view illustrating a honeycomb unit of the honeycomb structure of FIG. 2A.

### DESCRIPTION OF THE EMBODIMENTS

Preferred embodiments of the present invention are described below with reference to the accompanying drawings.

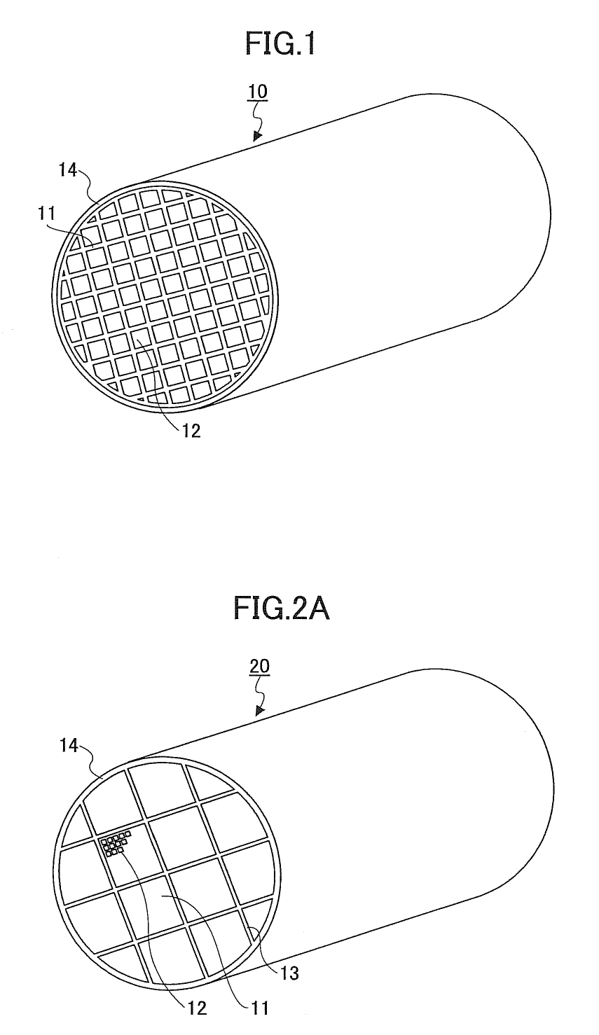

FIG. 1 shows a honeycomb structure 10 according to an embodiment of the present invention. The honeycomb structure 10 includes a single honeycomb unit 11 including zeolite and inorganic binder and having plural through holes 12 that are aligned in the longitudinal direction and are separated from each other by partition walls. A peripheral coating layer 14 is formed on the peripheral surface of the honeycomb unit 11. The thermal conductivity of the honeycomb unit 11 is in the range about 0.15-about 0.60 W/m/K, and preferably in the range about 0.20-about 0.40 W/m/K. The Young's modulus of the honeycomb unit 11 is in the range about 1.5-about 7.0 MPa, and preferably in the range about 3.0-about 6.5 MPa. With this configuration, the honeycomb structure 10 can easily prevent fracture due to thermal shock, and can be applied to an exhaust gas treating device in which a DOC is disposed upstream an SCR system (e.g., a urea SCR system) in a direction of exhaust gas flow.

If the thermal conductivity of the honeycomb unit 11 is about 0.15 W/m/K or greater, a temperature gradient is not easily produced within the honeycomb unit 11, so that the honeycomb unit 11 becomes less likely to fracture due to thermal stress. On the other hand, if the thermal conductivity of the honeycomb unit 11 is about 0.60 W/m/K or less, the porosity inside the honeycomb unit 11 is not easily reduced and hence the Young's modulus is not easily increased, so that the honeycomb unit 11 becomes less likely to fracture. If the Young's modulus of the honeycomb structure 11 is about 1.5 MPa or greater, the honeycomb unit 11 is less likely to have insufficient strength. On the other hand, if the Young's modulus is about 7.0 MPa or less, the honeycomb unit 11 becomes less likely to fracture.

The content of zeolite per apparent volume in the honeycomb unit 11 is preferably in the range about 230-about 270 g/L. If the content of zeolite per apparent volume in the honeycomb unit 11 is about 230 g/L or greater, a sufficient NOx conversion efficiency is easily obtained and hence the apparent volume of the honeycomb unit 11 does not need to be increased. On the other hand, if the content of zeolite per apparent volume is about 270 g/L or less, the strength of the honeycomb unit 11 does not easily become insufficient.

Non-exclusive examples of zeolite may include β zeolite, ZSM-5 zeolite, mordenite, faujasite, zeolite A, and zeolite L. These may be used alone or in combination of two or more.

Zeolite may preferably have a molar ratio of silica to alumina in the range about 30-about 50.

Zeolite may be ion exchanged in order to improve the ammonia absorption capacity. Non-exclusive examples of cationic species with which zeolite is ion exchanged may include Fe, Cu, Ni, Co, Zn, Mn, Ti, Ag, and V. These may be used alone or in combination of two or more. The ion exchange amount is preferably in the range about 1.0-about 10.0 wt %, and more preferably in the range about 1.0-about 5.0 wt %. If the ion exchange amount is about 1.0 wt % or greater, improvement in the ammonia absorption capacity by ion exchange does not easily become insufficient. On the other hand, if the ion exchange amount is about 10.0 wt % or less, the structure does not easily become instable when heat is applied. For ion exchange of zeolite, zeolite may be immersed in a solution containing cations.

Zeolite may preferably contain secondary particles. The average particle diameter of the secondary particles of zeolite is preferably in the range about 0.5-about 10 μm. If the average particle diameter of the secondary particles of zeolite is about 0.5 μm or greater, a large amount of inorganic binder does not need to be added, which may make extrusion molding less difficult. On the other hand, if the average particle diameter is about 10 μm or less, the specific surface area of zeolite is not easily reduced, and hence the NOx conversion efficiency is not easily reduced.

In order to improve the strength, the honeycomb unit 11 may further include inorganic particles excluding zeolite (hereinafter referred to as “non-zeolite inorganic particles”). Non-exclusive examples of non-zeolite inorganic particles may include alumina, silica, titania, zirconia, ceria, mullite, and precursors of these materials. These may be used alone or in combination of two or more. Alumina and zirconia are preferable among them.

The average particle diameter of the non-zeolite inorganic particles is preferably in the range about 0.5-about 10 μm. If the average particle diameter is about 0.5 μm or greater, a large amount of inorganic binder does not need to be added, which may make extrusion molding less difficult. On the other hand, if the average particle diameter is about 10 μm or less, the effect of increasing the strength of the honeycomb unit 11 does not easily become insufficient. The non-zeolite inorganic particles may contain secondary particles.

The ratio of the average diameter of the secondary particles of the non-zeolite inorganic particles to the average diameter of the secondary particles of zeolite is preferably about 1 or less, and more preferably in the range about 0.1-about 1. If this ratio is about 1 or less, the effect of increasing the strength of the honeycomb unit 11 does not easily become insufficient.

The content of the non-zeolite inorganic particles in the honeycomb unit 11 is preferably in the range about 3-about 30 wt %, and more preferably in the range about 5-about 20 wt %. If the content is about 3 wt % or greater, the effect of increasing the strength of the honeycomb unit 11 does not easily become insufficient. On the other hand, if the content is about 30 wt % or less, the content of zeolite in the honeycomb unit 11 is not easily reduced, and hence the NOx conversion efficiency is not easily reduced.

Non-exclusive examples of an inorganic binder include solid content contained in alumina sol, silica sol, titanium sol, liquid glass, sepiolite, and attapulgite. These may be used alone or in combination of two of more.

The content of the inorganic binder in the honeycomb unit 11 is preferably in the range about 5-about 30 wt %, and more preferably in the range about 10-about 20 wt %. If the inorganic binder content is about 5 wt % or greater, the strength of the honeycomb unit 11 is not easily reduced. If the inorganic binder content is about 30 wt % or less, molding does not easily become difficult.

The honeycomb unit 11 may preferably further include inorganic fibers for increased strength.

The inorganic fibers may be any kind of inorganic fiber that can increase the strength of the honeycomb unit 11. Non-exclusive examples of inorganic fibers may include alumina, silica, silicon carbide, silica alumina, glass, potassium titanate, and aluminum borate. These may be used alone or in combination of two or more.

The aspect ratio of the inorganic fibers is preferably in the range about 2-about 1,000, more preferably in the range about 5-about 800, and still more preferably in the range about 10-about 500. If the aspect ratio is about 2 or greater, the effect of increasing the strength of the honeycomb unit 11 is not easily reduced. On the other hand, if the aspect ratio is about 1,000 or less, clogging or the like does not easily occur in a mold during molding using an extrusion molding process or the like. Further, inorganic fibers are not easily broken during the molding process, so that the effect of increasing the strength of the honeycomb unit 11 is not easily reduced.

The content of the inorganic fibers in the honeycomb unit 11 is preferably in the range about 3-about 50 wt %, more preferably in the range about 3-about 30 wt %, and still more preferably in the range about 5-about 20 wt %. If the content of the inorganic fibers is about 3 wt % or greater, the effect of increasing the strength of the honeycomb unit 11 is not easily reduced. On the other hand, if the content is about 50 wt % or less, the content of zeolite in the honeycomb unit 11 is not easily reduced, and hence the NOx conversion efficiency is not easily reduced.

In the honeycomb unit 11, the aperture ratio in the cross section perpendicular to the longitudinal direction is preferably in the range about 50-about 65%. If the aperture ratio is about 50% or greater, zeolite in NOx conversion is easily efficiently used. If the aperture ratio is about 65% or less, the strength of the honeycomb structure 10 does not easily become insufficient.

In the honeycomb unit 11, the density of the through holes 12 in the cross section perpendicular to the longitudinal direction is preferably in the range about 15.5-about 124 holes/cm², and more preferably in the range about 31-about 93 holes/cm². If the density of the through holes 12 is about 15.5 holes/cm² or greater, it is easy to bring exhaust gas and zeolite into contact with each other, so that the NOx conversion efficiency of the honeycomb unit 11 is not easily reduced. On the other hand, if the density of the through holes 12 is about 93 holes/cm² or less, pressure loss of the honeycomb unit 11 is not easily increased.

The thickness of the partition walls between the through holes 12 of the honeycomb unit 11 is preferably in the range about 0.10-about 0.50 mm, and more preferably in the range about 0.15-about 0.35 mm. If the partition wall thickness is about 0.10 mm or greater, the strength of the honeycomb unit 11 is not easily reduced. On the other hand, if the partition wall thickness is about 0.50 mm or less, it is easy for exhaust gas to penetrate into the partition walls, and hence zeolite in NOx conversion is easily efficiently used.

The thickness of the peripheral coating layer 14 is preferably in the range about 0.1-about 2 mm. If the thickness of the peripheral coating layer 14 is about 0.1 mm or greater, the effect of increasing the strength of the honeycomb unit 11 does not easily become insufficient. On the other hand, if the thickness of the peripheral coating layer 14 is about 2 mm or less, the content of zeolite per unit volume in the honeycomb structure 10 is not easily reduced, so that the NOx conversion efficiency of the honeycomb structure 10 is not easily reduced.

Although the honeycomb structure 10 of the illustrated embodiment of the present invention has a cylindrical shape, the honeycomb structure 10 may have any shape such as a rectangular pillar shape and a cylindroid shape.

Although the through holes 12 of the illustrated embodiment of the present invention have a rectangular pillar shape, the through holes 12 may have any shape such as a triangular pillar shape and a hexagonal pillar shape.

An example of a manufacturing method of the honeycomb structure 10 is described below. First, a raw material paste, which contains zeolite and inorganic binder and, if necessary, further contains non-zeolite inorganic particles and inorganic fibers, is molded using an extrusion molding process or the like to form a raw cylindrical honeycomb molded body having plural through holes that are aligned in the longitudinal direction and are separated from each other by partition walls. Thus, a cylindrical honeycomb unit 11 having sufficient strength can be obtained even if fired at low temperatures.

Examples of an inorganic binder contained in the raw material paste may include alumina sol, silica sol, titanium sol, liquid glass, sepiolite, and attapulgite. These may be used alone or in combination of two of more.

An organic binder, a pore-forming agent, a dispersion solvent, a molding assisting agent, and the like may be added to the raw material paste if necessary.

Non-exclusive examples of a pore-forming agent may include balloons, which are hollow microspheres of oxide ceramic, spherical acrylic particles, and graphite. These may be used alone or in combination of two or more. Examples of balloons may include alumina balloons, glass micro-balloons, shirasu balloons, fly ash balloons (FA balloons), and mullite balloons.

Non-exclusive examples of an organic binder may include methylcellulose, carboxymethylcellulose, hydroxyethylcellulose, polyethyleneglycol, phenol resin, and epoxy resin. These may be used alone or in combination of two or more. The content of the organic binder is preferably in the range about 1-about 10% of the total weight of zeolite, the non-zeolite inorganic particles, the inorganic fibers, and the inorganic binder.

In an embodiment of the present invention, the Young's modulus of the honeycomb unit 11 may easily be adjusted using the organic binder and the pore-forming agent.

Non-exclusive examples of a dispersion solvent may include organic solvent, such as water and benzene, and alcohol, such as methanol. These may be used alone or in combination of two or more.

Non-exclusive examples of a molding assisting agent may include ethylene glycol, dextrin, fatty acid, fatty acid soap, and polyalcohol. These may be used alone or in combination of two or more.

When preparing the raw material paste, the components of the raw material paste are preferably mixed and kneaded. These components may be mixed using a mixer, an attritor or the like, and be kneaded using a kneader or the like.

The resulting honeycomb molded body is dried using a drying apparatus such as a microwave drying apparatus, a hot air drying apparatus, a dielectric drying apparatus, a low-pressure drying apparatus, a vacuum drying apparatus, and a freezing drying apparatus.

Then, the resulting honeycomb molded body is degreased. Although degreasing conditions may be suitably selected according to the kind and amount of organic substances contained in the molded body, degreasing is preferably performed at about 400° C. for about 2 hours.

Then, the resulting honeycomb molded body is fired to obtain a cylindrical honeycomb unit 11. The firing temperature is preferably in the range about 600-about 1,200° C., and more preferably in the range about 600-about 1,000° C. If the firing temperature is about 600° C. or greater, firing progresses easily, and hence the strength of the honeycomb structure 10 is not easily reduced. If the firing temperature is about 1,200° C. or less, firing does not easily progress excessively, and hence the reaction sites of zeolite are not easily reduced.

Then, a peripheral coating paste is applied onto the peripheral surface of the cylindrical honeycomb unit 11. Non-exclusive examples of a peripheral coating paste may include a mixture of an inorganic binder and inorganic particles, a mixture of an inorganic binder and inorganic fibers, and a mixture of an inorganic binder, inorganic particles, and inorganic fibers.

The peripheral coating paste may contain an organic binder. Non-exclusive examples of an organic binder may include polyvinyl alcohol, methylcellulose, ethylcellulose, and carboxymethylcellulose. These may be used alone or in combination of two or more.

The honeycomb unit 11 with the peripheral coating paste applied thereon is dried and solidified to obtain a cylindrical honeycomb structure 10. In the case where the peripheral coating paste contains an organic binder, degreasing is preferably performed. Although degreasing conditions may be suitably selected according to the kind and amount of organic substances, degreasing is preferably performed at about 700° C. for about 20 minutes.

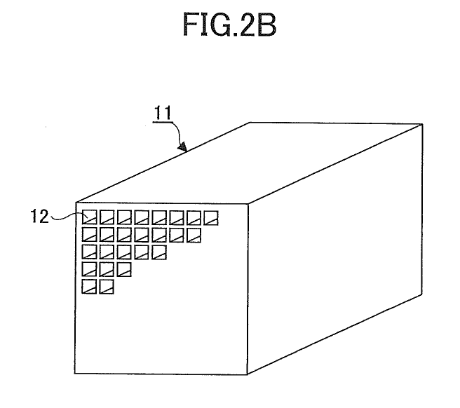

FIGS. 2A and 2B show another honeycomb structure 20 according to an embodiment of the present invention. The honeycomb structure 20 is the same as the honeycomb structure 10 except that plural honeycomb units 11, each having plural through holes 12 that are aligned in the longitudinal direction and are separated from each other by partition walls, are bonded to each other by interposing adhesive layers 13.

The area of the cross section of the honeycomb unit 11 perpendicular to the longitudinal direction is preferably in the range about 5-about 50 cm². If a cross-sectional area is about 5 cm² or greater, the specific surface area of the honeycomb structure 10 is not easily reduced, and hence the pressure loss is not easily increased. If a cross-sectional area is about 50 cm² or less, the strength against thermal stress in the honeycomb unit 11 does not easily become insufficient.

The thickness of the adhesive layers 13 bonding the honeycomb units 11 to each other is preferably in the range about 0.5-about 2 mm. If the thickness of the adhesive layers 13 is about 0.5 mm or greater, the adhesive strength does not easily become insufficient. On the other hand, if the thickness of the adhesive layers 13 is about 2 mm or less, the specific surface area of the honeycomb structure 10 is not easily reduced, and hence the pressure loss is not easily increased.

Although the honeycomb unit 11 of the illustrated embodiment of the present invention has a square pillar shape, the honeycomb unit 11 may have any shape, preferably shapes such as a hexagonal pillar shape that allow easy bonding of the honeycomb units 11.

An example of a manufacturing method of the honeycomb structure 20 is described below. Square-pillar-shaped honeycomb units 11 are manufactured in the same manner as the honeycomb structure 10. Then, an adhesive paste is applied onto the peripheral surfaces of the honeycomb units 11 to bond the honeycomb units 11 to each other. The adhesive paste is dried and solidified to form an assembly of the honeycomb units 11. After forming the assembly of the honeycomb units 11, the assembly may be cut into a cylindrical shape and be polished. Alternatively, honeycomb units 11 molded in sector shapes or square shapes in cross section may be bonded to each other to form a cylindrical assembly of the honeycomb units 11.

Non-exclusive examples of an adhesive paste may include a mixture of an inorganic binder and inorganic particles, a mixture of an inorganic binder and inorganic fibers, and a mixture of an inorganic binder, inorganic particles, and inorganic fibers.

The adhesive paste may contain an organic binder. Non-exclusive examples of an organic binder may include polyvinyl alcohol, methylcellulose, ethylcellulose, and carboxymethylcellulose. These may be used alone or in combination of two or more.

Then, a peripheral coating paste is applied onto the peripheral surface of the cylindrical assembly of the honeycomb units 11. The peripheral coating paste may contain the same materials as the materials of the adhesive paste or may contain different materials. The peripheral coating paste may have the same composition as the composition of the adhesive paste.

The assembly of the honeycomb units 11 with the peripheral coating paste applied thereon is dried and solidified to obtain a cylindrical honeycomb structure 20. In the case where the adhesive paste and/or the peripheral coating paste contains an organic binder, degreasing is preferably performed. Although degreasing conditions may be suitably selected according to the kind and amount of organic substances, degreasing is preferably performed at about 700° C. for about 20 minutes.

Note that the honeycomb structures 10 and 20 may be manufactured in the following way. A honeycomb structure is formed using a raw material paste containing non-ion exchanged zeolite and then is immersed in a solution containing cations for ion exchange of zeolite.

In an embodiment of the present invention, a honeycomb structure may or may not have a peripheral coating layer.

If a conventional honeycomb structure including zeolite is used in an SCR system, since HC that has not been oxidized by a DOC is adsorbed onto zeolite, ignition of HC desorbed at high temperature causes thermal shock fracture.

According to an embodiment of the present invention, it is possible to provide a honeycomb structure capable of preventing fracture due to thermal shock.

### EXAMPLES

### Example 1

First, 2,250 g of β zeolite having 3 wt % ion exchanged with Fe, 2 μm average particle diameter, a silica/alumina ratio of 40, and 110 m²/g specific surface area; 2,600 g of alumina sol of 20 wt % solid content as a component containing an inorganic binder; 550 g of γ alumina of 2 μm average particle diameter as inorganic particles; 780 g of alumina fibers of 1 μm average fiber diameter and 25 μm average fiber length as inorganic fibers; and 410 g of methylcellulose as an organic binder were mixed and kneaded to obtain a raw material paste 1. Note that zeolite particles were immersed in an iron nitrate solution to be ion exchanged with Fe. The ion exchange amount of zeolite was measured by IPC emission analysis using ICPS-8100 (manufactured by Shimadzu Corporation). Then, the raw material paste 1 was molded by extrusion molding using an extruder to obtain a raw cylindrical honeycomb molded body. The honeycomb molded body was dried using a microwave drying apparatus and a hot air drying apparatus, and was then degreased at 400° C. for 5 hours. Then, the honeycomb molded body was dried at 600° C. for 5 hours to obtain a cylindrical honeycomb unit 11 of 143 mm diameter and 150 mm length. The obtained honeycomb unit 11 has a 60% aperture ratio in the cross section perpendicular to the longitudinal direction, a through hole density of 78 through holes/cm², 0.25 mm partition wall thickness, and 250 g/L zeolite content per apparent volume.

The aperture ratio was found by calculating the area of the through holes in an area of 10 cm by 10 cm of the honeycomb structure using an optical microscope. The density of the through holes was found by counting the number of the through holes in an area of 10 cm by 10 cm of the honeycomb structure using an optical microscope. The partition wall thickness is an average value of the partition wall thicknesses at several locations (five locations) measured using an optical microscope.

The honeycomb unit 11 has a thermal conductivity of 0.16 W/m/K and a Young's modulus of 7.0 MPa (see Table 1).

The thermal conductivity was measured at 600° C. using LF/TCM-FA8510B (manufactured by Rigaku Corporation). The Young's modulus was measured at 600° C. using a JE-RT type modulus measuring device (manufactured by Nihon Techno-plus Co. Ltd.) according to the JIS R 1605 standard. Here, a sample of 10 mm×10 mm×30 mm cut from the honeycomb unit 11 was used.

The contents of JIS R 1605 standard are incorporated by reference in their entirety.

Next, 29 parts by weight of γ alumina of 2 μm average particle diameter as inorganic particles, 7 parts by weight of alumina fibers of 6 μm average fiber diameter and 100 μm average fiber length as inorganic fibers, 34 parts by weight of alumina sol of 20 wt % solid content as a component containing an inorganic binder, 5 parts by weight of methylcellulose as an organic binder, and 25 parts by weight of water were mixed and kneaded to obtain a peripheral coating paste.

Then, the peripheral coating paste was applied onto the peripheral surface of the honeycomb unit 11 to form a peripheral coating layer 14 of 0.4 mm thickness. After that, the honeycomb unit 11 was dried and solidified at 120° C. by using a microwave drying apparatus and a hot air drying apparatus, and was then degreased at 400° C. for 2 hours to obtain a cylindrical honeycomb structure 10 of 143.8 mm diameter and 150 mm length.

### Example 2

In this example, 2,250 g of β zeolite having 3 wt % ion exchanged with Fe, 2 μm average particle diameter, a silica/alumina ratio of 40, and 110 m²/g specific surface area; 2,600 g of alumina sol of 20 wt % solid content; 410 g of γ alumina of 2 μm average particle diameter; 120 g of acrylic resin of 10 μm average particle diameter as a pore-forming agent; 780 g of alumina fibers of 1 μm average fiber diameter and 25 μm average fiber length; and 410 g of methylcellulose were mixed and kneaded to obtain a raw material paste 2.

A honeycomb structure 10 was manufactured in the same manner as in Example 1 except that the raw material paste 2 was used instead of the raw material paste 1 (see Table 1).

### Example 3

In this example, 2,250 g of β zeolite having 3 wt % ion exchanged with Fe, μm average particle diameter, a silica/alumina ratio of 40, and 110 m²/g specific surface area; 2,600 g of alumina sol of 20 wt % solid content; 190 g of γ alumina of 2 μm average particle diameter; 300 g of acrylic resin of 10 μm average particle diameter as a pore-forming agent; 780 g of alumina fibers of 1 μm average fiber diameter and 25 μm average fiber length; and 410 g of methylcellulose were mixed and kneaded to obtain a raw material paste 3.

A honeycomb structure 10 was manufactured in the same manner as in Example 1 except that the raw material paste 3 was used instead of the raw material paste 1 (see Table 1).

### Example 4

A honeycomb structure 10 was manufactured in the same manner as in Example 1 except that the firing temperature was 1,000° C. instead of 600° C. (see Table 1).

### Example 5

A raw material paste 4 was obtained in the same manner as in Example 4 except that aluminum borate fibers of 1 μm average fiber diameter and 25 μm average fiber length were used instead of alumina fibers of 1 μm average fiber diameter and 25 μm average fiber length.

A honeycomb structure 10 was manufactured in the same manner as in Example 4 except that the raw material paste 4 was used instead of the raw material paste 1 (see Table 1).

### Example 6

In this example, 2,250 g of β zeolite having 3 wt % ion exchanged with Fe, 2 μm average particle diameter, a silica/alumina ratio of 40, and 110 m²/g specific surface area; 2,600 g of alumina sol of 20 wt % solid content; 600 g of acrylic resin of 10 μm average particle diameter as a pore-forming agent; 650 g of alumina fibers of 1 μm average fiber diameter and 25 μm average fiber length; and 410 g of methylcellulose were mixed and kneaded to obtain a raw material paste 5.

A honeycomb structure 10 was manufactured in the same manner as in Example 4 except that the raw material paste 5 was used instead of the raw material paste 1 (see Table 1).

### Example 7

A raw material paste 6 was obtained in the same manner as in Example 2 except that silicon carbide fibers of 1 μm average fiber diameter and 25 μm average fiber length were used instead of alumina fibers of 1 μm average fiber diameter and 25 μm average fiber length.

A honeycomb structure 10 was manufactured in the same manner as in Example 1 except that the raw material paste 6 was used instead of the raw material paste 1 (see Table 1).

### Example 8

A raw material paste 7 was obtained in the same manner as in Example 3 except that silicon carbide fibers of 1 μm average fiber diameter and 25 μm average fiber length were used instead of alumina fibers of 1 μm average fiber diameter and 25 μm average fiber length.

A honeycomb structure 10 was manufactured in the same manner as in Example 1 except that the raw material paste 7 was used instead of the raw material paste 1 (see Table 1).

### Example 9

A raw material paste 8 was obtained in the same manner as in Example 6 except that silicon carbide fibers of 1 μm average fiber diameter and 25 μm average fiber length were used instead of alumina fibers of 1 μm average fiber diameter and 25 μm average fiber length.

A honeycomb structure 10 was manufactured in the same manner as in Example 1 except that the raw material paste 8 was used instead of the raw material paste 1 (see Table 1).

### Comparative Example 1

A honeycomb structure 10 was manufactured in the same manner as in Example 7 except that the firing temperature was 800° C. instead of 600° C. (see Table 1).

### Comparative Example 2

A honeycomb structure 10 was manufactured in the same manner as in Example 9 except that the firing temperature was 800° C. instead of 600° C. (see Table 1).

### Comparative Example 3

A raw material paste 9 was obtained in the same manner as in Example 1 except that silica-alumina fibers of 1 μm average fiber diameter and 25 μm average fiber length were used instead of alumina fibers of 1 μm average fiber diameter and 25 μm average fiber length.

A honeycomb structure 10 was manufactured in the same manner as in Example 1 except that the raw material paste 9 was used instead of the raw material paste 1 (see Table 1).

### Comparative Example 4

A raw material paste 10 was obtained in the same manner as in Example 3 except that silica-alumina fibers of 1 μm average fiber diameter and 25 μm average fiber length were used instead of alumina fibers of 1 μm average fiber diameter and 25 μm average fiber length.

A honeycomb structure 10 was manufactured in the same manner as in Example 1 except that the raw material paste 10 was used instead of the raw material paste 1 (see Table 1).

### Comparative Example 5

In this example, 2,250 g of β zeolite having 3 wt % ion exchanged with Fe, 2 μm average particle diameter, a silica/alumina ratio of 40, and 110 m²/g specific surface area; 2,600 g of alumina sol of 20 wt % solid content; 675 g of γ alumina of 2 μm average particle diameter; 700 g of alumina fibers of 1 μm average fiber diameter and 25 μm average fiber length; and 410 g of methylcellulose were mixed and kneaded to obtain a raw material paste 11.

A honeycomb structure 10 was manufactured in the same manner as in Example 1 except that the raw material paste 11 was used instead of the raw material paste 1 (see Table 1).

### Comparative Example 6

A raw material paste 12 was obtained in the same manner as in Example 9 except that alumina fibers of 1 μm average fiber diameter and 25 μm average fiber length were used instead of silicon carbide fibers of 1 μm average fiber diameter and 25 μm average fiber length.

A honeycomb structure 10 was manufactured in the same manner as in Comparative Example 1 except that the raw material paste 12 was used instead of the raw material paste 1 (see Table 1).

### Comparative Example 7

A honeycomb structure 10 was manufactured in the same manner as in Example 4 except that the raw material paste 11 was used instead of the raw material paste 1 (see Table 1).

### Comparative Example 8

A raw material paste 13 was obtained in the same manner as in Example 9 except that aluminum borate fibers of 1 μm average fiber diameter and 25 μm average fiber length were used instead of silicon carbide fibers of 1 μm average fiber diameter and 25 μm average fiber length.

A honeycomb structure 10 was manufactured in the same manner as in Example 4 except that the raw material paste 13 was used instead of the raw material paste 1 (see Table 1).

### Comparative Example 9

A raw material paste 14 was obtained in the same manner as in Example 1 except that silicon carbide fibers of 1 μm average fiber diameter and 25 μm average fiber length were used instead of alumina fibers of 1 μm average fiber diameter and 25 μm average fiber length.

A honeycomb structure 10 was manufactured in the same manner as in Example 1 except that the raw material paste 14 was used instead of the raw material paste 1 (see Table 1).

TABLE 1

| | RAW | FIRING | THERMAL | YOUNG'S | THERMAL |
|---|---|---|---|---|---|
| | MATERIAL | TEMPERATURE | CONDUCTIVITY | MODULUS | SHOCK |
| | PASTE | [° C.] | [W/m/K] | [MPa] | TEST |
| EXAMPLE 1 | 1 | 600 | 0.16 | 7.0 | Good |
| EXAMPLE 2 | 2 | 600 | 0.16 | 5.0 | Good |
| EXAMPLE 3 | 3 | 600 | 0.16 | 2.3 | Good |
| EXAMPLE 4 | 1 | 1000 | 0.35 | 6.5 | Good |
| EXAMPLE 5 | 4 | 1000 | 0.37 | 4.5 | Good |
| EXAMPLE 6 | 5 | 1000 | 0.35 | 2.3 | Good |
| EXAMPLE 7 | 6 | 600 | 0.60 | 5.7 | Good |
| EXAMPLE 8 | 7 | 600 | 0.60 | 4.3 | Good |
| EXAMPLE 9 | 8 | 600 | 0.60 | 2.8 | Good |
| COMPARATIVE | 6 | 800 | 0.70 | 5.7 | Bad |
| EXAMPLE 1 | | | | | |
| COMPARATIVE | 8 | 800 | 0.70 | 2.8 | Bad |
| EXAMPLE 2 | | | | | |
| COMPARATIVE | 9 | 600 | 0.12 | 5.4 | Bad |
| EXAMPLE 3 | | | | | |
| COMPARATIVE | 10 | 600 | 0.12 | 3.0 | Bad |
| EXAMPLE 4 | | | | | |
| COMPARATIVE | 11 | 600 | 0.16 | 7.2 | Bad |
| EXAMPLE 5 | | | | | |
| COMPARATIVE | 12 | 600 | 0.20 | 1.9 | Bad |
| EXAMPLE 6 | | | | | |
| COMPARATIVE | 11 | 1000 | 0.35 | 7.2 | Bad |
| EXAMPLE 7 | | | | | |
| COMPARATIVE | 13 | 1000 | 0.37 | 1.8 | Bad |
| EXAMPLE 8 | | | | | |
| COMPARATIVE | 14 | 600 | 0.60 | 7.1 | Bad |
| EXAMPLE 9 | | | | | |

<Thermal Shock Test>

An alumina mat of 6 mm thickness (46.5 cm×15 cm) (manufactured by Mitsubishi Chemical Corporation) was wound on the peripheral surface of each of the honeycomb structures of Examples 1-9 and Comparative Examples 1-9. The honeycomb structure was placed and pushed into a metal casing using Instron and thus was canned.

The canned honeycomb structure was placed in a firing furnace at 600° C. and was heated for 10 minutes. Then, the honeycomb structure was removed from the firing furnace and was cooled naturally to room temperature. This process was repeated ten times. Then, it was visually determined whether there was a crack. The results are shown in the above Table 1. In Table 1, “Good” indicates that there was no crack and “Bad” indicates that there was a crack. Table 1 suggests that the honeycomb structures of Examples 1-9 have less risk of developing cracks due to thermal shock than the honeycomb structures of Comparative Examples 1-9.

These results show that if the honeycomb unit 11 has thermal conductivity in the range about 0.15-about 0.60 W/m/K and Young's modulus in the range about 1.5-about 7.0 MPa, it is possible to easily prevent fracture of the honeycomb structure 10 due to thermal shock.

Obviously, numerous modifications and variations of the present invention are possible in light of the above teachings. It is therefore to be understood that within the scope of the appended claims, the invention may be practiced otherwise than as specifically described herein.

What is claimed as new and is desired to be secured by Letters Patent of the United States is:

1. A honeycomb structure comprising:
a honeycomb unit having thermal conductivity equal to or greater than about 0.15 W/m/K but less than or equal to about 0.60 W/m/K and having Young's modulus equal to or greater than about 1.5 MPa but less than or equal to about 7.0 MPa, the honeycomb unit comprising:
zeolite;
an inorganic binder; and
partition walls extending along a longitudinal direction of the honeycomb unit to define plural through holes.

2. The honeycomb structure as claimed in claim 1, wherein a content of the zeolite per apparent volume in the honeycomb unit is equal to or greater than about 230 g/L but less than or equal to about 270 g/L.

3. The honeycomb structure as claimed in claim 1, wherein the zeolite comprises at least one of β zeolite, Y zeolite, ferrierite, ZSM-5 zeolite, mordenite, faujasite, zeolite A, and zeolite L.

4. The honeycomb structure as claimed in claim 1, wherein the zeolite has a molar ratio of silica to alumina equal to or greater than about 30 but less than or equal to about 50.

5. The honeycomb structure as claimed in claim 1, wherein the zeolite is ion exchanged with at least one of Fe, Cu, Ni, Co, Zn, Mn, Ti, Ag and V.

6. The honeycomb structure as claimed in claim 1, wherein the zeolite further comprises secondary particles of average particle diameter equal to or greater than about 0.5 μm but less than or equal to about 10 μm.

7. The honeycomb structure as claimed in claim 1, wherein the honeycomb unit further includes non-zeolite inorganic particles.

8. The honeycomb structure as claimed in claim 7, wherein the inorganic particles comprise at least one of alumina, silica, titania, zirconia, ceria, mullite, and precursors thereof.

9. The honeycomb structure as claimed in claim 1, wherein the inorganic binder comprises solid content contained in at least one of alumina sol, silica sol, titanium sol, liquid glass, sepiolite, and attapulgite.

10. The honeycomb structure as claimed in claim 1, wherein the honeycomb unit further comprises inorganic fibers.

11. The honeycomb structure as claimed in claim 10, wherein the inorganic fibers comprise at least one of alumina, silica, silicon carbide, silica alumina, glass, potassium titanate, and aluminum borate.

12. The honeycomb structure as claimed in claim 1, wherein an aperture ratio in a cross section perpendicular to the longitudinal direction in the honeycomb unit is equal to or greater than about 50% but less than or equal to about 65%.

13. The honeycomb structure as claimed in claim 1, wherein the honeycomb structure comprises plural honeycomb units which are bonded to each other via adhesive layers provided between the plural honeycomb units.

14. The honeycomb structure as claimed in claim 1, wherein the honeycomb unit is singular.

15. The honeycomb structure as claimed in claim 1, further comprising:
a coating layer defining a peripheral surface of the honeycomb structure.

16. The honeycomb structure as claimed in claim 1, wherein the honeycomb structure is so constructed to be applied to an exhaust gas treating device in which a diesel oxidation catalyst is disposed upstream a selective catalytic reduction system in a direction of exhaust gas flow.

17. The honeycomb structure as claimed in claim 5, wherein an ion exchange amount is in a range from about 1.0 to about 10.0 wt %.

18. The honeycomb structure as claimed in claim 7, wherein an average particle diameter of the non-zeolite inorganic particles is in a range from about 0.5 to about 10 μm.

19. The honeycomb structure as claimed in claim 7, wherein the non-zeolite inorganic particles contain secondary particles.

20. The honeycomb structure as claimed in claim 19, wherein a ratio of an average diameter of the secondary particles of the non-zeolite inorganic particles to an average diameter of secondary particles of zeolite is about 1 or less.

21. The honeycomb structure as claimed in claim 7, wherein a content of the non-zeolite inorganic particles in the honeycomb unit is in a range from about 3 to about 30 wt %.

22. The honeycomb structure as claimed in claim 1, wherein a content of the inorganic binder in the honeycomb unit is in a range of romg about 5 to about 30 wt %.

23. The honeycomb structure as claimed in claim 10, wherein an aspect ratio of the inorganic fibers is in a range from about 2 to about 1,000.

24. The honeycomb structure as claimed in claim 10, wherein a content of the inorganic fibers in the honeycomb unit is in a range from about 3 to about 50 wt %.

25. The honeycomb structure as claimed in claim 1, wherein a density of the through holes in a cross section perpendicular to the longitudinal direction is in a range from about 15.5 to about 124 holes/cm².

26. The honeycomb structure as claimed in claim 1, wherein a thickness of the partition walls is in a range from about 0.10 to about 0.50 mm.

27. The honeycomb structure as claimed in claim 13, wherein an area of a cross section of the honeycomb unit perpendicular to the longitudinal direction is in a range from about 5 to about 50 cm².

28. The honeycomb structure as claimed in claim 1, wherein a peripheral surface of the honeycomb structure is processed by cutting.

29. The honeycomb structure as claimed in claim 1, wherein the honeycomb structure comprises a plurality of honeycomb units that are bonded to each other and that are molded in sector shapes or square shapes in cross section perpendicular to the longitudinal direction.
